(19) United States
(12) Patent Application Publication
(10) Pub. No.: US 2010/0140531 A1
(43) Pub. Date: Jun. 10, 2010

(54) USE OF A BETAINE AS A FOAM DRAINAGE REDUCING AGENT

(75) Inventors: Evelyne Prat, Pantin (FR); Sylvie Touzet, Anthony (FR); Florence Deschaseaux, Paris (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Rhodia Operations, Aubervilliers Cedex (FR)

(21) Appl. No.: 12/530,183

(22) PCT Filed: Mar. 3, 2008
(86) PCT No.: PCT/EP2008/052553

§ 371 Date: Jan. 20, 2010

(30) Foreign Application Priority Data
Mar. 8, 2007 (FR) 07/01696

(51) Int. Cl. C11D 17/00; C09K 8/22; C04B 40/00; C04B 38/00; C08J 9/00; C09D 11/00; A62D 1/04; C04B 16/08; C11D 3/30

(52) U.S. Cl. 252/3; 507/131; 510/433; 106/823; 501/80; 521/128; 106/31.97; 510/135; 106/677; 510/235

(57) ABSTRACT

The invention relates to the use of a betaine as a foam drainage reducing agent. The invention also relates to the use of betaine in processes involving foam.

### FIELD OF THE INVENTION

A subject matter of the present invention is the use of a betaine as foam drainage reducing agent. Another subject matter of the present invention is the use of the betaine in processes involving the presence of foam.

### BACKGROUND

Some industrial processes or processes carried out in the private domain employ foams. In some detergent compositions, the foam is a sign, valued by the consumer, of a good cleaning power. In these compositions, the foam also makes it possible to suspend the soiling matter cleaned off and thus to separate it from the cleaned object or from the cleaned surface. Foams are also used in fire extinguishing products. Foams are also used to generate light and/or porous materials: the material cures starting from the composition forming the walls of the bubbles, which results in a structure comprising pores corresponding to the bubbles. Foams are also used to suspend and transport debris in construction operations, in the field of construction and civil engineering, in particular in operations for excavating and/or boring tunnels. The foam is also used as visual marker on ground surfaces. Foams are also used in water treatment as decontaminating agent for removing particles or soiling matter.

Numerous agents exist which are capable of generating foam. The most widely used among these are anionic surfactants, in particular alkyl ether sulfates, which exhibit a useful detergent power and generate a valued foam. A zwitterionic surfactant, cocoamidopropyldi-methyl betaine, is also known and widely used.

Numerous “foam booster” compounds have been described in order to increase the volume of foam, in particular polymers. Such polymers are used in particular in compositions for the washing of dishes by hand.

The processes described above may require a relatively lengthy lifetime of the foam, without which the operations and phenomena may not be brought to completion or experience a reduced effectiveness. For example, in the generation of a light material, the foam must remain present during the curing time. The earlier the foam drains away, the fewer pores there will be bringing about the desired lightness and/or the desired porosity. In excavation operations, the earlier the foam disappears, the less material will be evacuated.

There exists a need for foams having reduced drainage, that is to say foams having a water content which is kept high for a longer time and/or retaining a certain volume of foam for a longer time. A consequence of the maintenance of the high water content is, for example, a high durability in the properties, in particular mechanical properties, and/or the retention of the shape of the bubbles and/or of the homogeneity. There exists a need for agents for this purpose.

### SUMMARY OF THE INVENTION

The invention meets this need by providing for the use, in a foaming aqueous composition comprising a foaming agent, as foam drainage reducing agent, of a betaine surfactant chosen from the following:
alkyl betaines of following formula (I):

R¹—N⁺R²R³—CH₂−COO⁻ (I)
alkylamidoalkyl betaines of following formula (II):

R′¹—CO—NH—R₄—N⁺R²R³—CH₂—COO⁻ (II), and
their mixtures and combinations,
   where:
R¹ represents a saturated or unsaturated and linear or branched alkyl group comprising from 16 to 24 carbon atoms,
R′¹ represents a saturated or unsaturated and linear or branched alkyl group comprising from 15 to 22 carbon atoms,
R⁴ represents a divalent C₁-C₄ alkyl group, if appropriate substituted by a hydroxyl group,
R² and R³, which are identical or different, represent a C₁-C₂ alkyl group, if appropriate substituted by a hydroxyl group.

The surfactant described above is subsequently referred to as “agent of the invention” or “betaine surfactant”. The combination of the foaming agent and of the betaine surfactant is subsequently referred to as “system of the invention”.

The invention also relates to a process for the preparation of foam in which an aqueous composition comprising a foaming agent and the agent of the invention is made to foam, for example by stirring and/or by propelling with the aid of a gas.

The invention also relates to processes comprising a stage of preparation of foam and another stage, simultaneous or subsequent. The processes may be industrial processes or processes carried out in the private domain. Interest is particularly marked in the context of industrial processes.

The invention makes it possible in particular:
to retain the foam for a longer time,
to retain the foam for the same time but with reduced amounts of agents, which is economic and/or beneficial to the environment, or at least perceived as such,
to retain the homogeneity of the foam for a longer time,
to make it easier to obtain low drainages, over broad composition ranges, and/or
to have a presence of an amount of foam, cumulative over time, which is greater.

Drainage is understood to mean the flow of the water present in the foam, which can result in the degradation of the walls of the bubbles and finally in the gradual return to the state of a bubble-free aqueous composition.

The use of the system of the invention is particularly practical and easy.

### DETAILED DESCRIPTION OF PREFERRED EMBODIMENTS

### Composition and Agent of the Invention

The composition is an aqueous composition comprising a foaming agent and the agent of the invention. The foaming agent exhibits the property of generating foam. Such agents are known. The foam can be generated by any conventional method, in particular by stirring, pressure reduction, employing a propellant gas, employing an aerosol device, and the like. The agent of the invention reduces the drainage, in comparison with the drainage obtained with the foaming agent alone. It is thus a drainage reducing agent. It is not out of the question for the agent of the invention to contribute to generating foam. However, this is not its main role in the system of the invention.

The foaming agent is a compound (or a combination of compounds) which is different from the betaine surfactant.

The foaming agents are known to a person skilled in the art. They can in particular be anionic, nonionic, amphoteric (including zwitterionic surfactants other than the betaine surfactant) or cationic surfactants or their mixtures and combinations.

Mention may in particular be made, as example of anionic surfactant foaming agent, of:
alkyl ester sulfonates of formula R—CH(SO₃M)-COOR′, where R represents a C₈₋₂₀, preferably C₁₀-C₁₆, alkyl radical, R′ represents a C₁-C₆, preferably C₁-C₃, alkyl radical and M represents an alkali metal (sodium, potassium or lithium) cation, a substituted or unsubstituted ammonium (methyl-, dimethyl-, trimethyl- or tetramethylammonium, dimethyl-piperidinium, and the like) cation or a cation derived from an alkanolamine (monoethanolamine, diethanolamine, triethanolamine, and the like). Mention may very particularly be made of methyl ester sulfonates in which the R radical is a C₁₄-C₁₆ radical;
α-olefin sulfonates comprising from 12 to 16 carbon atoms;
alkyl sulfates and alkyl ether sulfates of formula ROSO₃M, where R represents a C₅-C₂₄, preferably C₁₀-C₁₈, alkyl or hydroxyalkyl radical and M represents a hydrogen atom or a cation with the same definition as above, and their ethoxylenated (EO) and/or propoxylenated (PO) derivatives, exhibiting on average from 0.5 to 30, preferably from 0.5 to 10, EO and/or PO units. Mention is in particular made of sodium dodecyl sulfate (SDS), ammonium dodecyl sulfate, sodium lauryl ether sulfate (SLES) or ammonium lauryl ether sulfate;
alkylamide sulfates of formula RCONHR′OSO₃M, where R represents a C₂-C₂₂, preferably C₆-C₂₀, alkyl radical, R¹ represents a C₂-C₃ alkylene radical and M represents a hydrogen atom or a cation with the same definition as above, and their ethoxylenated (EO) and/or propoxylenated (PO) derivatives exhibiting on average from 0.5 to 60 EO and/or PO units;
salts of saturated or unsaturated C₈-C₂₄, preferably C₁₄-C₂₀, fatty acids, C₉-C₂₀ alkylbenzenesulfonates, C₈-C₂₂ primary or secondary alkylsulfonates, alkylglycerolsulfonates, the sulfonated poly-carboxylic acids described in GB-A-1 082 179, paraffin sulfonates, N-acyl-N-alkyltaurates, alkyl phosphates, isethionates, alkylsuccinamates, alkyl sulfosuccinates, sulfosuccinate monoesters or diesters, N-acyl-sarcosinates, alkylglycoside sulfates, or polyethoxycarboxylates, the cation being an alkali metal (sodium, potassium or lithium), a substituted or unsubstituted ammonium residue (methyl-, dimethyl-, trimethyl- or tetramethylammonium, dimethylpiperidinium, or the like) or a residue derived from an alkanolamine (monoethanolamine, diethanolamine, triethanolamine, or the like);
alkyl or alkylaryl phosphate esters, such as Rhodafac RA600, Rhodafac PA15 or Rhodafac PA23, sold by Rhodia.

The amount, expressed on a dry basis, of anionic surface-active agent (when it is present) can range from 0.5 to 90 parts by weight, preferably from 5 to 60 parts by weight, more particularly from 10 to 30 parts by weight, per 100 parts by total weight of detergent composition.

Mention may in particular be made, among nonionic surface-active foaming agents, of condensates of alkylene oxide, in particular of ethylene oxide, with alcohols, polyols or alkylphenols; fatty acid esters; fatty acid amides; fatty amines; sugar derivatives, such as alkylpolyglycosides or esters of fatty acids and of sugars, in particular sucrose monopalmitate; long-chain tertiary phosphine oxides; dialkyl sulfoxides; block copolymers of polyoxyethylene and of polyoxypropylene; polyalkoxylated sorbitan esters; fatty esters of sorbitan, poly(ethylene oxide)s and fatty acid amides modified so as to give them a hydrophobic nature (for example, fatty acid mono- and diethanolamides comprising from 10 to 18 carbon atoms).

Mention may very particularly be made of:
polyoxyalkylenated (polyethoxyethylenated, polyoxy-propylenated or polyoxybutylenated) alkylphenols in which the alkyl substituent is a C₆-C₁₂ alkyl substituent and which comprise from 5 to 25 oxyalkylene units; mention may be made, by way of example, of Triton X-45, X-114, X-100 or X-102, sold by Rohm & Haas Co.;
glucosamides, glucamides or glycerolamides;
polyoxyalkylenated C₈-C₂₂ aliphatic alcohols comprising from 1 to 25 oxyalkylene (oxyethylene or oxypropylene) units. Mention may be made, by way of example, of Tergitol 15-S-9 or Tergitol 24-L-6 NMW, sold by Union Carbide Corp., Neodol 45-9, Neodol 23-65, Neodol 45-7 or Neodol 45-4, sold by Shell Chemical Co., or Rhodasurf IDO60, Rhodasurf LA90 or Rhodasurf IT070, sold by Rhodia;
the alkylpolyglycosides described in U.S. Pat. No. 4,565,647;
optionally polyhydroxylated C₈-C₂₀ fatty acid amides;
ethoxylated fatty acids;
ethoxylated amines.

Mention may in particular be made, as amphoteric or zwitterionic surface-active foaming agents, of:
amine oxides, such as (C₁₀-C₁₈ alkyl)dimethylamine oxides or (C₈-C₂₂ alkoxy)ethyldihydroxyethylamine oxides;
aliphatic quaternary ammonium derivatives, in particular 3-(N,N-dimethyl-N-hexadecylammonio)-propane-1-sulfonate and 3-(N,N-dimethyl-N-hexadecylammonio)-2-hydroxypropane-1-sulfonate;
betaines other than the agents of the invention, sulfobetaines and carboxylates and sulfonates of fatty acids and of imidazole;
alkylamidopropyldimethyl sulfobetaines, such as Mirataine CBS, sold by Rhodia;
condensation products of fatty acids and of protein hydrolysates;
alkyldimethyl sulfobetaines;
alkyl amphoacetates or alkyl amphodiacetates, the alkyl group of which comprises from 6 to 20 carbon atoms;
amphoteric alkylpolyamine derivatives, such as Amphionic XL®, sold by Rhodia, or Ampholac 7T/X® and Ampholac 7C/X®, sold by Berol Nobel.

Mention may in particular be made, as cationic surface-active foaming agents, of:
alkylammonium salts of formula R¹R²R³R⁴N⁺X⁻ where
   X⁻ represents a halide, CH₃SO₄⁻ or C₂H₅SO₄⁻ ion;
   R¹ and R² are alike or different and represent a C₁-C₂₀ alkyl radical, an aryl radical or a benzyl radical;
   R³ and R⁴ are alike or different and represent a C₁-C₂₀ alkyl radical, an aryl radical, a benzyl radical or an ethylene oxide and/or propylene oxide condensate (CH₂CH₂O)ₓ—(CH₂CHCH₃O)y-H, where x and y range from 0 to 30 and are never simultaneously zero,
   in particular cetyltrimethylammonium bromide, Rhodaquat® TFR, sold by Rhodia.

The ratio by weight of the betaine surfactant to the foaming agent can in particular be greater than or equal to 0.4, preferably 0.7, preferably 1, preferably 2.

The ratio by weight of the betaine surfactant to the foaming agent can in particular be less than or equal to 10, preferably 4, preferably 3, preferably 2.

The composition can in particular comprise from 0.05 to 5% by weight, preferably from 0.1 to 2% by weight, preferably from 0.15 to 1.5% by weight, preferably from 0.2 to 0.7% by weight, of the foaming agent and of the betaine surfactant (it is a matter of the content by weight of the system of the invention), while preferably observing the ratios indicated above.

The composition can in particular comprise from 0.05 to 2% by weight, preferably from 0.1 to 1% by weight, preferably from 0.15 to 0.7% by weight, of the betaine surfactant, while preferably observing the ratios indicated above.

The composition can in particular comprise from 0.1 to 3% by weight, preferably from 0.15 to 1.5% by weight, preferably from 0.2 to 1% by weight, of the foaming agent, while preferably observing the ratios indicated above.

Preferably, in the agent of the invention:
R² and R³ are methyl groups, and
R⁴ is the —CH₂—CH₂—CH₂— group.

### Advantageously:

R¹ represents a saturated or unsaturated and linear or branched alkyl group comprising from 18 to 22 carbon atoms, or
R′¹ represents a saturated or unsaturated and linear or branched alkyl group comprising from 17 to 21 carbon atoms.

### Preferably:

R¹ represents a saturated or unsaturated and linear or branched alkyl group comprising 18 carbon atoms, or
R′¹ represents a saturated or unsaturated and linear or branched alkyl group comprising 17 carbon atoms.

It is mentioned that the R¹ and R′¹ groups can correspond to residues of fatty acids, generally of natural origin, most often of vegetable origin. The fatty acid to which R′¹ corresponds is the fatty acid of formula R′¹—COOH. The fatty acid to which R¹ corresponds is the fatty acid exhibiting the same number of carbon atoms. Thus, the R′¹ group can correspond to a saturated or unsaturated and linear or branched fatty acid comprising from 15 to 23, preferably from 17 to 21, preferably 17, carbon atoms. The R¹ group can correspond to a saturated or unsaturated and linear or branched fatty acid comprising from 16 to 24, preferably from 18 to 22, preferably 18, carbon atoms. It is normal to put the R¹ and R′¹ groups in the same category as the fatty acid to which they correspond.

These groups and fatty acids are known. Generally, vegetable oil derivatives are involved. They can be present as mixtures. If mixtures are concerned, all the groups (or corresponding fatty acids), whatever the number of carbon atoms, come within the definition if the predominant group (or corresponding acid) by weight (relative predominance, preferably absolute predominance, preferably to at least 75%) corresponds to the definition. Frequently, the name of the group (or of the corresponding acid) is reduced to that of the predominant group (or acid).

The R¹ and R′¹ groups can in particular correspond to C₁₈ or C₂₂ fatty acids, such as stearic, oleic or erucic acids. Preferably, they correspond to an oleyl group.

Combinations of the betaine surfactant and of a foaming agent of the alkyl sulfate and alkyl ether sulfate type prove to be particularly effective in the reduction in the drainage.

The composition can comprise all kinds of additional ingredients, depending on its destination and its use.

The water of the composition preferably exhibits a moderate hardness, preferably a hardness ranging from 5 to 100° TH [French degree of hardness], for example from 20 to 60. Such conditions may improve the reduction in the drainage.

The pH of the composition can be varied. It can be controlled using known agents. The pH can in particular be greater than or equal to 4 or 5, preferably greater than or equal to 7, for example from 8-9 to 11-12. High pH values may improve the reduction in the drainage.

The composition and the processes in which it is employed can be of varied temperature. It is, for example, between 20° C. and 80° C., preferably between 20° C. and 40° C. or between 40° C. and 80° C. Moderate temperatures may improve the reduction in the drainage. The invention makes it possible in particular to retain a low drainage at relatively high temperatures, for example between 40° C. and 80° C., which renders it particularly useful and advantageous in certain processes carried out at relatively high temperatures.

The composition can be prepared by simple mixing of water, of the foaming agent, of the agent of the invention and optionally of other ingredients. According to a specific form, the foaming agent and the agent of the invention are premixed in the form of a solid or liquid composition referred to as a “concentrated composition”. The concentrated composition can, for example, comprise at least 2% by weight, preferably at least 5% by weight, for example at least 10% by weight, of the system of the invention. The concentrated composition can be subsequently diluted, for example immediately before generating the foam and/or before or during the addition of other ingredients. The use of concentrated compositions is particularly simple for the user and provides good effects in reduction of the drainage.

### Uses and Processes

The foaming composition can in particular be:
a composition comprising a hydraulic binder,
a composition for the manufacture of ceramics, which can in particular comprise a slip,
a drilling fluid,
a composition comprising compounds capable of generating a crosslinked polymeric material,
a composition for marking a ground surface,
a composition for extinguishing fires,
a composition for decontaminating water,
a foam bath composition, or
a detergent composition.

Such compositions are known to a person skilled in the art. They generally comprise supplementary compounds in addition to the agents of the invention. These are known to a person skilled in the art. Processes employing foams with such compositions are known to a person skilled in the art.

For the compositions comprising a hydraulic binder, these can in particular be cement compositions or plaster compositions for obtaining a porous and/or light and/or refractory and/or insulating material, for example a material for thermal and/or acoustic insulation. The agent of the invention can in particular be used in a process (generally of industrial type) where the composition having a hydraulic binder is made to foam and then the composition is allowed to harden in the foam form, in order to obtain the material. Another process can be to prepare a dispersion of the binder in water, to incorporate therein a foam obtained using the system of the invention and then to allow the composition to harden. Such processes can in particular be employed in order to obtain prefabricated materials, such as prefabricated structural parts.

It is the same for the compositions capable of generating an optionally crosslinked polymeric material, the hydraulic binder being replaced by a polymer, which can, if appropriate, crosslink on contact with ambient air, or by a chemical system having several compounds comprising at least one polymer or oligomer, it being possible for said system optionally to crosslink when the several compounds are brought into contact, if appropriate under the action of contact with ambient air. The compositions capable of generating a polymeric material can, for example, be latex-based compositions for addition to fibrous products, for example carpet backings and/or nonwoven surfaces. The compositions capable of generating a polymeric material can also be used in the papermaking industry.

The invention can confer good uniformity on the materials having a hydraulic binder or having a polymeric base.

For the compositions for the manufacture of porous ceramics (for example based on oxides), the compositions can in particular be compositions comprising a slip. The agent of the invention can in particular be used in a process where the foam is introduced into the slip (composition based on water and on ceramic precursor) so as to obtain a handleable unfired porous part which is subsequently subjected to a temperature profile in a furnace so as to obtain a porous part by sintering the oxides at high temperature.

For the drilling fluids, they can be fluids for excavating debris employed in tunnel boring operations or in well hollowing operations, before cementation of the well. The agent of the invention can in particular be used in a process (generally of industrial type) where the composition is made to foam, it is injected into a boring or hollowing device, such as a tunnel-boring machine, and the foam carrying (generally) the debris is evacuated from the region of contact of the device and of the bored or hollowed rock. The foam makes it possible in particular to prevent collapses of rock, to evacuate the debris, to fluidize the bored or hollowed rock, to homogenize it and/or to render it impermeable locally and, if appropriate, temporarily.

For the compositions for extinguishing fires, they can in particular be compositions for extinguishers or compositions employed in building safety systems. The invention provides foams having a good resistance to heat, which makes the use thereof particularly appropriate in the context of the extinguishing of fires. The fires to be extinguished can be fires occurring in buildings and/or in forests or on farms, and/or fires related to the combustion of hydrocarbons, for example during accidental or deliberate fires in plants for the extraction, storage or transportation of oil and/or gas.

For the detergent compositions, they can be compositions for cleaning dishes by hand, shampoos or shower gels for the body and hair, liquid soaps for washing the hands, compositions for washing laundry by hand or in a semiautomatic machine, detergent formulations for washing vehicles, such as cars and trucks, compositions for the household or industrial cleaning of surfaces, where it may be advantageous for the foam to have a sufficient lifetime to allow a cleaning action (for example, for the cleaning of bathrooms). In these compositions, the invention can provide, by the presence of foam, a visual sign of complete coverage of the object or of the part of the object to be cleaned. The agent of the invention can in particular be used in a process (generally carried out in the private domain) where the composition is diluted and is made to foam (by stirring, often generated by the movement of the hands or by a jet of diluting water) and the dirty dish is brought into contact with the dilute foam-exhibiting composition.

A process involving marking a ground surface comprises a stage of generating foam and a stage where the foam is left on the ground surface in order to mark it. The more the foam hardens, the more persistent the marking. The foam can be left on the ground surface by spraying it from an aircraft, for example a plane. This can be used in the military field, to identify operational areas, or in the agricultural field, to identify treatment areas.

Other details or advantages of the invention may become apparent in the light of the examples which follow, without a limiting nature.

### Examples 1 to 20

### Products Used

Mirataine BET C30, Rhodia (“BET C30”): cocoamido-propyldimethyl betaine
Empicol ESB3M, Huntsman (“SLES”): sodium lauryl ether sulfate—active material 27%
SDS: sodium dodecyl sulfate
Miranol C2M Conc. NP, Rhodia (“C2M”): INCI name “Disodium cocoamphoacetate”—active material 50%
Mirataine BET O-30, Rhodia (“BET O30”): oleamido-propyldimethyl betaine
Mackam OB-30, McIntyre (“OB30”): oleyldimethyl betaine
Mirataine BET E-40, Rhodia (“BET E40”): mixture comprising erucylamidopropyldimethyl betaine (40% by weight of active material) and 20% by weight of isopropanol.
Mixture 1: mixture of Mirataine BET E-40 and 10% by weight of benzyltrimethylammonium chloride,
Water: faucet water (“municipal water”) from Aubervilliers, France, December 2007 (hardness of approximately 30° TH).

### Equipment Used

Rayneri stirrer
3-blade propeller
21 plastic beaker with a diameter of 14.5 cm
Glass cone

### Implementation of the Drainage Test

The drainage is characterized by the half-life of the foam (by volume). The greater the half-life, the lower the drainage. The procedure is as follows:
1—Preparation of 200 ml of composition by mixing the ingredients (compositions given below), if appropriate under hot conditions (80° C.). The compositions are given below: amount of the ingredients as active material, the remainder being water.
2—Foaming
The composition is stirred in a 2 liter beaker with a 3-blade propeller at 2000 rev/min for 5 min. The volume of foam produced is recorded.
3—The draining is monitored in a 1 liter cone until the foam has released 100 ml of water (½ life as this is half the initial composition used to prepare the foam).

The drainage improvement factor F_{additive} is defined as the ratio of the ½ life obtained with the combination of the foaming agent and the test compound to the ½ life for the foaming agent alone. A factor of 1 provides no improvement. The higher F_{additive}, the more the drainage is reduced. A factor of greater than 1.75 represents an advantageous improvement in the drainage of greater than 75%.

In the examples, the letter C indicates a comparative example.

The results are given in table I. They show that the agents of the invention bring about a significant reduction in the drainage, over a broad range of compositions, which makes it practical to use them.

TABLE I

| | | | | | Foaming | Total | | | |
|---|---|---|---|---|---|---|---|---|---|
| | | | Additive | | agent/ | amount | | ½ | |
| | Foaming agent | | tested | | additive | of the | | Life | |
| Example | Nature | Amount | Nature | Amount | ratio | system | ½ Life | (s) | F_{additive} |
| 1C | SLES | 0.24% | / | / | | 0.24% | 6 min (360 s) | 360 | 1 |
| 2C | SLES | 0.42% | / | / | | 0.42% | 7 min 19 s (439 s) | 439 | 1 |
| 3C | SLES | 0.96% | / | / | | 0.0096 | 7 min 10 s (430 s) | 430 | 1 |
| 4 | SLES | 0.24% | BET E40 | 0.18% | 0.75 | 0.42% | 11 min 9 s | 669 | 1.85 |
| 5 | SLES | 0.24% | BET E40 | 0.72% | 3 | 0.96% | 11 min 54 s | 714 | 1.98 |
| 6 | SLES | 0.315% | BET E40 | 0.105% | 0.34 | 0.42% | 8 min 30 s | 510 | / |
| 7 | SLES | 0.24% | BET O30 | 0.18% | 0.75 | 0.42% | 28 min | 1680 | 4.6 |
| 8 | SLES | 0.24% | BET O30 | 0.72% | 3 | 0.96% | >18 h | 64 800 | 180 |
| 9 | SLES | 0.315% | BET O30 | 0.105% | 0.34 | 0.42% | 9 min 23 s | 653 | / |
| 10 | SLES | 0.0072% | BET O30 | 0.24% | 0.34 | 0.96% | 8 min 24 s | 504 | / |
| 11C | SLES | 0.24% | BET C30 | 0.18% | 0.75 | 0.42% | 9 min 30 s | 570 | 1.58 |
| 12C | SLES | 0.24% | BET C30 | 0.72% | 3 | 0.96% | 11 min 54 s | 714 | 1.98 |
| 13C | SLES | 0.72% | BET C30 | 0.24% | 0.34 | 0.96% | 9 min | 540 | 1.25 |
| 14C | SLES | 0.24% | C2M | 0.18% | 0.75 | 0.42% | 10 min 8 s | 609 | 1.69 |
| 15 | SLES | 0.24% | OB30 | 0.18% | 0.75 | 0.42% | 10 min 30 s | 630 | 1.75 |
| 16 | SLES | 0.24% | OB30 | 0.72% | 3 | 0.96% | 11 min | 660 | 7.83 |
| 17 | SDS | 0.42% | / | / | | 0.42% | 7 min 30 s | 450 | 1 |
| 18 | SDS | 0.24% | BET E40 | 0.18% | 0.75 | 0.42% | 20 min | 1200 | / |
| 19 | SDS | 0.24% | BET O30 | 0.18% | 0.75 | 0.42% | 27 min 25 s | 1645 | / |
| 20 | SDS | 0.24% | BET O30 | 0.72% | 3 | 0.96% | 30 min 14 s | 1814 | / |

### Example 21

### Preparation of a Porous Plaster

A foam is prepared by stirring an aqueous composition, comprising 0.24% by weight of SLES and 0.72% by weight of Mirataine BET O30 in municipal water, at 2000 rev/min for five minutes with a deflocculating paddle.

A dispersion of plaster (Lutèce® Express, sold by Placoplatre or BPB Placo) in water is then prepared by adding 100 grams of plaster to 80 grams of water stirred with a deflocculating paddle rotating at 200 rev/min. When the dispersion is homogeneous, 12.5 grams of foam are incorporated therein.

The composition is thus as follows:

| | | |
|---|---|---|
| plaster | 100 | g |
| water | 92.38 | g |
| SLES | 0.03 | g |
| Mirataine BET O30 | 0.09 | g |

After setting, a plaster with a density of between 0.45 and 0.5 with a homogeneous and uniform porosity is obtained.

1-14. (canceled)

15. A process of reducing foam drainage comprising:
adding a betaine surfactant to a foaming aqueous composition comprising a foaming agent, wherein said betaine surfactant comprises:
alkyl betaines of following formula (I):
R¹—N⁺R²R³—CH₂—COO⁻ (I)
alkylamidoalkyl betaines of following formula (II):
R′¹—CO—NH—R⁴—N⁺R²R³—CH₂—COO⁻ (II)
and
mixtures and combinations thereof,
wherein:
R¹ represents a saturated or unsaturated and linear or branched alkyl group comprising from 16 to 24 carbon atoms,
R′¹ represents a saturated or unsaturated and linear or branched alkyl group comprising from 15 to 22 carbon atoms,
R⁴ represents a divalent C₁-C₄ alkyl group, optionally substituted by a hydroxyl group,
R² and R³, which are identical or different, represent a C₁-C₂ alkyl group, optionally substituted by a hydroxyl group.

16. The process of claim 15, wherein the ratio by weight of the betaine surfactant to the foaming agent is greater than or equal to 0.4.

17. The process of claim 16, wherein the ratio by weight of the betaine surfactant to the foaming agent is greater than or equal to 2.

18. The process of claim 15, wherein the ratio of the betaine surfactant to the foaming agent by weight is less than or equal to 10.

19. The process of claim 18, wherein the ratio by weight of the betaine surfactant to the foaming agent by weight is less than or equal to 2.

20. The process of claim 15, wherein the composition comprises the foaming agent and the betaine surfactant together in an amount ranging from 0.05 to 5% by weight of the composition.

21. The process of claim 20, wherein the composition comprises the foaming agent and the betaine surfactant together in an amount ranging from 0.2 to 0.7% by weight of the composition.

22. The process of claim 15, wherein the composition comprises betaine surfactant in an amount ranging from 0.05 to 2% by weight.

23. The process of claim 22, wherein the composition comprises betaine surfactant in an amount ranging from 0.15 to 0.7% by weight.

24. The process of claim 15, wherein the composition comprises an amount of foaming agent ranging from 0.1 to 3% by weight.

25. The process of claim 24, wherein the composition comprises an amount of foaming agent ranging from 0.2 to 1% by weight.

26. The process of claim 15, wherein:
R² and R³ are methyl groups, and
R⁴ is a —CH₂—CH₂—CH₂— group.

27. The process of claim 15, wherein:
R¹ represents a saturated or unsaturated and linear or branched alkyl group comprising 18 carbon atoms, or
R′¹ represents a saturated or unsaturated and linear or branched alkyl group comprising 17 carbon atoms.

28. The process of claim 15, wherein:
the R¹ group or the R′¹ group is an oleyl group.

29. The process of claim 15, wherein the foaming agent comprises an alkyl sulfate, an alkyl ether sulfate, or mixtures thereof.

30. The process of claim 15, wherein the foaming composition is:
a composition comprising a hydraulic binder,
a ceramic manufacturing composition,
a drilling fluid,
a composition comprising compounds capable of generating a polymeric material that is optionally crosslinked,
a ground surface marking composition,
a fire extinguishing composition,
a water decontaminating composition,
a foam bath composition, or
a detergent composition.

31. The process of claim 30, wherein the composition comprising a hydraulic binder is a cement composition or a plaster composition capable of producing a porous and/or light and/or refractory and/or insulating material.

32. The process of claim 30, wherein the drilling fluid is capable of evacuating debris in a tunnel drilling operation.

33. The process of claim 30, wherein the detergent composition is a handwashing dish detergent.
